(19) United States
(12) Patent Application Publication
(10) Pub. No.: US 2026/0159394 A1
(43) Pub. Date: Jun. 11, 2026

(54) MANUFACTURING METHOD FOR POROUS BIO-CARBON MATERIAL

(71) Applicant: CPC CORPORATION, TAIWAN, Kaohsiung City (TW)

(72) Inventors: Tzu-Hsien HSIEH, Kaohsiung City (TW); Yu-Hsien LIAO, Kaohsiung City (TW); Po-Hung WANG, Kaohsiung City (TW); Jarrn-Horng LIN, Kaohsiung City (TW); Yang-Chuang CHANG, Kaohsiung City (TW)

(73) Assignee: CPC CORPORATION, TAIWAN, Kaohsiung City (TW)

(21) Appl. No.: 19/046,819

(22) Filed: Feb. 6, 2025

(30) Foreign Application Priority Data
Dec. 5, 2024 (TW) 113147147

(51) Int. Cl. C01B 32/05

(52) U.S. Cl. CPC C01B 32/05; C01P 2006/12

(57) ABSTRACT

Disclosed is a manufacturing method for a porous bio-carbon material, comprising a material stacking step of sequentially stacking a bio-carbon source and iron oxide in layers from bottom to top to form a raw material stack; and a heat treatment step of performing a heat treatment on the raw material stack to reduce the iron oxide and cause the bio-carbon source to react with carbon dioxide generated during the reduction to form pores and result in the porous bio-carbon material.

### FIELD OF THE INVENTION

The present invention relates to a manufacturing method for a porous bio-carbon material, and more particularly relates to a method capable of simultaneously manufacturing the porous bio-carbon material and producing reduced iron.

### BACKGROUND OF THE INVENTION

Porous bio-carbon materials are widely used in the field of electrochemistry, such as in the production of electrodes for lithium-ion batteries, lithium-ion capacitors or supercapacitors.

The current mainstream method for manufacturing porous bio-carbon materials is to mix bio-oil produced by the thermochemical treatment of biomass with a template. However, the template method requires the use of an activating agent and involves multiple heating and cooling stages during the process, resulting in a complicated procedure with high equipment and production costs.

### SUMMARY OF THE INVENTION

Therefore, one objective of the present invention is to provide a manufacturing method for a porous bio-carbon material, which can manufacture porous bio-carbon materials through a simple process and obtain by-product reduced iron powder, thereby simplifying the manufacturing process for porous bio-carbon materials and improving economic benefits.

In order to overcome the technical problems in prior art, the present invention provides a manufacturing method for a porous bio-carbon material, comprising: a material stacking step of sequentially stacking a bio-carbon source and iron oxide in layers from bottom to top to form a raw material stack; and a heat treatment step of performing a heat treatment on the raw material stack to reduce the iron oxide and cause the bio-carbon source to react with carbon dioxide generated during the reduction to form pores and result in the porous bio-carbon material.

One embodiment of the present invention provides a manufacturing method, wherein in the material stacking step, calcium carbonate is further used, the raw material stack is formed by sequentially stacking the calcium carbonate, the bio-carbon source and the iron oxide in layers from bottom to top.

One embodiment of the present invention provides a manufacturing method, wherein the bio-carbon source is glucose or lignin.

One embodiment of the present invention provides a manufacturing method, wherein the bio-carbon source used in the material stacking step has a carbon content of 40 to 90%.

One embodiment of the present invention provides a manufacturing method, wherein in the material stacking step, the iron oxide has a particle size of 1 to 100 μm.

One embodiment of the present invention provides a manufacturing method, wherein in the material stacking step, the weight ratio of the iron oxide to the bio-carbon source is from 1:9 to 9:1.

One embodiment of the present invention provides a manufacturing method, wherein the heat treatment is performed at a temperature of 700 to 1000° C.

One embodiment of the present invention provides a manufacturing method further comprising, after the heat treatment step, a washing step of performing an acid wash treatment on the porous bio-carbon material, and then performing a water wash treatment to remove inorganic substances from the porous bio-carbon material.

One embodiment of the present invention provides a manufacturing method, wherein the specific surface area of the porous bio-carbon material is from 400 to 2000 m²/g.

With the technical means adopted by the present invention, the manufacturing method of the present invention can manufacture the porous bio-carbon material through a simple process and obtain by-product reduced iron powder, thereby simplifying the manufacturing process for the porous bio-carbon materials and improving economic benefits.

### BRIEF DESCRIPTION OF THE DRAWINGS

FIG. 1 is a flow chart of a manufacturing method for a porous bio-carbon material according to an embodiment of the present invention.

### DETAILED DESCRIPTION OF THE PREFERRED EMBODIMENTS

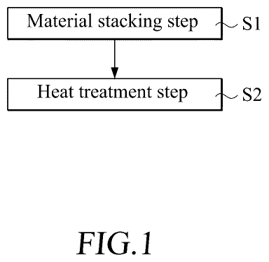

The preferred embodiments of the present invention are described in detail below with reference to FIG. 1. The description is used for explaining the embodiments of the present invention only, but not for limiting the scope of the claims.

As showed in FIG. 1, a manufacturing method for a porous bio-carbon material according to one embodiment of the present invention comprises: a material stacking step S1 of sequentially stacking a bio-carbon source and iron oxide in layers from bottom to top to form a raw material stack; and a heat treatment step S2 of performing a heat treatment on the raw material stack to reduce the iron oxide and cause the bio-carbon source to react with carbon dioxide generated during the reduction to form pores and result in the porous bio-carbon material.

According to the technical means of the present invention, carbon monoxide and volatiles produced during the heat treatment of bio-carbon undergo a reduction reaction with iron oxide, resulting in reduced iron powder and carbon dioxide. The carbon dioxide obtained by the above reaction can be used to react with bio-carbon to form pores, thereby obtaining porous bio-carbon materials with a high surface area.

In the above reduction reaction, 5 to 95% of the iron oxide used as the raw material can be reduced to micron-sized reduced iron powder.

In the manufacturing method according to one embodiment of the present invention, in the material stacking step S1, calcium carbonate is further used, the raw material stack is formed by sequentially stacking the calcium carbonate, the bio-carbon source and the iron oxide in layers from bottom to top.

According to the technical means of the present invention, calcium carbonate is added to the raw material stack, and the calcium carbonate is heated to generate carbon dioxide, which further reacts with the bio-carbon to form pores, resulting in a porous bio-carbon carbon material with a higher surface area.

In the manufacturing method according to one embodiment of the present invention, the bio-carbon source is glucose or lignin.

In the manufacturing method of the present invention, the bio-carbon source is not specifically limited as long as it is a biomass material. Biomass waste, glucose, lignin, and various carbon-containing biomass resources can be used. In particular, by using glucose or lignin as the bio-carbon source, the material cost can be reduced, and the quality of the resulting porous bio-carbon material can be improved.

In the manufacturing method according to one embodiment of the present invention, the bio-carbon source used in the material stacking step S1 has a carbon content of 40 to 90%.

In the manufacturing method according to one embodiment of the present invention, in the material stacking step S1, the iron oxide has a particle size of 1 to 100 μm.

In the manufacturing method according to one embodiment of the present invention, the weight ratio of the iron oxide to the bio-carbon source is from 1:9 to 9:1 in the material stacking step S1.

In the manufacturing method according to one embodiment of the present invention, the heat treatment is performed at a temperature of 700 to 1000° C.

In the manufacturing method according to one embodiment of the present invention, the manufacturing method further comprises, after the heat treatment step S2, a washing step of performing an acid wash treatment on the porous bio-carbon material, and then performing a water wash treatment to remove inorganic substances from the porous bio-carbon material.

### Example 1

10.0 g of oyster shell powder, 12.0 g of bio-carbon powder and 16.0 g of iron oxide powder are sequentially stacked in layers from bottom to top to form a raw material stack. The raw material stack is placed into a ceramic crucible and heated from room temperature to 900° C. at a heating rate of 5° C. per minute. After maintaining the temperature at 900° C. for 2 hours, the resulting reduced iron and porous bio-carbon material are obtained and weighed. The results are shown in table 1.

TABLE 1

| Product | Weight (g.) |
|---|---|
| Reduced iron | 11.4 |
| Porous bio-carbon material | 5.0 |

As shown in table 1, the reduction rate of iron powder is 96%, and the yield of porous bio-carbon material is 42%. The obtained porous bio-carbon material is subjected to acid-washing with hydrochloric acid to remove impurities, followed by water washing to neutralize it. After drying the carbon sample, the surface area is measured by nitrogen adsorption-desorption method. The measured surface area of the porous bio-carbon material is 670 m²/g.

### Example 2

500 g of oyster shell powder, 600 g of bio-carbon powder and 650 g of iron oxide powder are sequentially stacked in layers from bottom to top to form a raw material stack. The raw material stack is placed into a ceramic crucible and heated from room temperature to 850° C. at a heating rate of 3° C. per minute. After maintaining the temperature at 850° C. for 8 hours, the resulting reduced iron and porous bio-carbon material are obtained and weighed. The results are shown in table 2.

TABLE 2

| Product | Weight (g.) |
|---|---|
| Reduced iron | 537 |
| Porous bio-carbon material | 300 |

As shown in table 2, the reduction rate of iron powder is 59%, and the yield of porous bio-carbon material is 50%. The obtained porous bio-carbon material is subjected to acid-washing with hydrochloric acid to remove impurities, followed by water washing to neutralize it. After drying the carbon sample, the surface area is measured by nitrogen adsorption-desorption method. The measured surface area of the porous bio-carbon material is 570 m²/g.

### Example 3

300 g of bio-carbon powder and 450 g of iron oxide powder are sequentially stacked in layers from bottom to top to form a raw material stack. The raw material stack is placed into a ceramic crucible and heated from room temperature to 850° C. at a heating rate of 3° C. per minute. After maintaining the temperature at 850° C. for 8 hours, the resulting reduced iron and porous bio-carbon material are obtained and weighed. The results are shown in table 3.

TABLE 3

| Product | Weight (g.) |
|---|---|
| Reduced iron | 327 |
| Porous bio-carbon material | 111 |

As shown in table 3, the reduction rate of iron powder is 91%, and the yield of porous bio-carbon material is 11%. The obtained porous bio-carbon material is subjected to acid-washing with hydrochloric acid to remove impurities, followed by water washing to neutralize it. After drying the carbon sample, the surface area is measured by nitrogen adsorption-desorption method. The measured surface area of the porous bio-carbon material is 1044.8 m²/g.

### Example 4

40 g of wood pellets and 45 g of iron oxide powder are sequentially stacked in layers from bottom to top to form a raw material stack. The raw material stack is placed into a ceramic crucible and heated from room temperature to 900° C. at a heating rate of 5° C. per minute. After maintaining the temperature at 900° C. for 2 hours, the resulting reduced iron and porous bio-carbon material are obtained and weighed. The results are shown in table 4.

TABLE 4

| Product | Weight (g.) |
|---|---|
| Reduced iron | 22.4 |
| Porous bio-carbon material | 3.2 |

As shown in table 4, the reduction rate of iron powder is 9%, and the yield of porous bio-carbon material is 9%. The obtained porous bio-carbon material is subjected to acid-washing with hydrochloric acid to remove impurities, followed by water washing to neutralize. After drying the carbon sample, the surface area is measured by nitrogen adsorption-desorption method. The measured surface area of the porous bio-carbon material is 2000 m²/g.

### Example 5

210 g of orchid materials and 315 g of iron oxide powder are sequentially stacked in layers from bottom to top to form a raw material stack. The raw material stack is placed into a ceramic crucible and heated from room temperature to 850° C. at a heating rate of 3° C. per minute. After maintaining the temperature at 850° C. for 24 hours, the resulting reduced iron and porous bio-carbon material are obtained and weighed. The results are shown in table 5.

TABLE 5

| Product | Weight (g.) |
|---|---|
| Reduced iron | 262 |
| Porous bio-carbon material | 91 |

As shown in table 5, the reduction rate of iron powder is 56%, and the yield of porous bio-carbon material is 43%. The obtained porous bio-carbon material is subjected to acid-washing with hydrochloric acid to remove impurities, followed by water washing to neutralize. After drying the carbon sample, the surface area is measured by nitrogen adsorption-desorption method. The measured surface area of the porous bio-carbon material is 586 m²/g.

### Example 5

200 g of coffee grounds and 200 g of iron oxide powder are sequentially stacked in layers from bottom to top to form a raw material stack. The raw material stack is placed into a ceramic crucible and heated from room temperature to 850° C. at a heating rate of 3° C. per minute. After maintaining the temperature at 850° C. for 24 hours, the resulting reduced iron and porous bio-carbon material are obtained and weighed. The results are shown in table 6.

TABLE 6

| Product | Weight (g.) |
|---|---|
| Reduced iron | 154 |
| Porous bio-carbon material | 4.7 |

As shown in table 6, the reduction rate of iron powder is 77%, and the yield of porous bio-carbon material is 2.4%. The obtained porous bio-carbon material is subjected to acid-washing with hydrochloric acid to remove impurities, followed by water washing to neutralize it. After drying the carbon sample, the surface area is measured by nitrogen adsorption-desorption method. The measured surface area of the porous bio-carbon material is 1240 m²/g.

With the manufacturing method according to the present invention, the manufacturing method of the present invention can manufacture the porous bio-carbon material through a simple process and obtain by-product reduced iron powder, thereby simplifying the manufacturing process for porous bio-carbon materials and improving economic benefits.

The above description should be considered as only the discussion of the preferred embodiments of the present invention. However, a person having ordinary skill in the art may make various modifications without deviating from the present invention. Those modifications still fall within the scope of the present invention.

What is claimed is:

1. A manufacturing method for a porous bio-carbon material, comprising:
a material stacking step of sequentially stacking a bio-carbon source and iron oxide in layers from bottom to top to form a raw material stack; and
a heat treatment step of performing a heat treatment on the raw material stack to reduce the iron oxide and cause the bio-carbon source to react with carbon dioxide generated during the reduction to form pores and result in the porous bio-carbon material.

2. The manufacturing method as claimed in claim 1, wherein in the material stacking step, calcium carbonate is further used, the raw material stack is formed by sequentially stacking the calcium carbonate, the bio-carbon source and the iron oxide in layers from bottom to top.

3. The manufacturing method as claimed in claim 1, wherein the bio-carbon source is glucose or lignin.

4. The manufacturing method as claimed in claim 1, wherein the bio-carbon source used in the material stacking step has a carbon content of 40 to 90%.

5. The manufacturing method as claimed in claim 1, wherein in the material stacking step, the iron oxide has a particle size of 1 to 100 μm.

6. The manufacturing method as claimed in claim 1, wherein in the material stacking step, the weight ratio of the iron oxide to the bio-carbon source is from 1:9 to 9:1.

7. The manufacturing method as claimed in claim 1, wherein the heat treatment is performed at a temperature of 700 to 1000° C.

8. The manufacturing method as claimed in claim 1, further comprising, after the heat treatment step, a washing step of performing an acid wash treatment on the porous bio-carbon material, and then performing a water wash treatment to remove inorganic substances from the porous bio-carbon material.

9. The manufacturing method as claimed in claim 1, wherein the specific surface area of the porous bio-carbon material is from 400 to 2000 m²/g.
